(19) United States
(12) Patent Application Publication
(10) Pub. No.: US 2009/0182441 A1
(43) Pub. Date: Jul. 16, 2009

(54) Control loop and method of creating a process model therefor

(75) Inventors: Franz Wintrich, Essen (DE); Volker Stephan, Hupstedt (DE)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Powitec Intelligent Technologies GmbH, Essen (DE)

(21) Appl. No.: 12/319,950

(22) Filed: Jan. 14, 2009

(30) Foreign Application Priority Data
Jan. 15, 2008 (EP) 08 000 618.2

(51) Int. Cl. G05B 13/04; G06F 15/18

(52) U.S. Cl. 700/44; 706/12; 700/274

(57) ABSTRACT

In a control loop for regulating a combustion process in a plant having a controlled system for converting material by way of the combustion, with at least one flame body being formed, the control loop having at least one observation device for imaging the flame body and further sensors to determine the state variables describing the state of the system in the plant, at least one regulator and/or a computer to evaluate the state variables and select suitable actions based on a process model, and adjustment devices for at least the supply of material and/or air that can be controlled by the actions, the process model provides specialized function approximators for various process dynamics, one of which function approximators is selected by a selector, and a regulator assigned to the selected function approximator is used to regulate the control loop.

### CROSS-REFERENCE TO RELATED APPLICATION

The present application claims priority to EP 08 000 618.2, which was filed Jan. 15, 2008. The entire disclosure of EP 08 000 618.2 is incorporated herein by reference.

### TECHNICAL FIELD

The present disclosure generally relates to a control loop for regulating a combustion process in a plant (e.g., a power-generating plant, a waste incineration plant or a plant for making cement) having a controlled system for converting material by way of the combustion process, with at least one flame body being formed, and the control loop having at least one observation device for imaging the flame body, further sensors for determining the state variables that describe the state of the system in the plant, and a controller for evaluating the state variables and selecting suitable actions based on a process model, and adjustment devices that can be controlled by the actions for at least the supply of the material and/or air.

### BACKGROUND

In a known method of the type described in the Technical Field section of this disclosure, the neural network is established by empirically selecting and then retaining the input channels, so that a static topology exists. As a result, there is a risk that significant channels are not considered and also that computing power is consumed for non-significant channels.

### BRIEF SUMMARY OF SOME ASPECTS OF THIS DISCLOSURE

An aspect of this disclosure is to take a control loop and better adapt it to the dynamic processes.

One aspect of this disclosure is the provision of a control loop for regulating a combustion process in a plant having a controlled system for converting material by way of the process so that at least one flame body is formed, with the control loop comprising sensors for determining state variables that describe the state of the system in the plant, wherein the sensors include at least one observation device for imaging at least the flame body; a plurality of function approximators respectively specialized for different process dynamics; a selector for selecting a function approximator of the plurality of function approximators; a regulator assigned to the selected function approximator for evaluating the state variables and selecting suitable actions; and at least one adjustment device that can be controlled by the actions for supplying at least the material and/or at least oxygen (e.g., air) to the process.

Another aspect of this disclosure is the provision of a method for creating a process model that may be used in a control loop for regulating a combustion process in a plant having a controlled system for converting material by way of the combustion process, with the method comprising determining state variables that describe the state of the system in the plant; specializing a plurality of function approximators respectively for different dynamics of the combustion process, including training the plurality of function approximators respectively to different time ranges; and then selecting a function approximator of the plurality of function approximators. A regulator, which is assigned to the selected function approximator, may be used to evaluate the state variables and select suitable actions, wherein the actions are for controlling at least one adjustment device for supplying at least the material and/or at least oxygen to the process.

Because the process model provides specialized function approximators for various process dynamics, and the specialized function approximators then have to be selected, it is possible to better approach the individual phases of the process with better predictions. The method employed by an exemplary embodiment of this disclosure is to model the process dynamics with adaptive, learning-capable and self-organizing function approximators, for example by using neural networks. In a training phase, during which several identically or differently structured function approximators operate in parallel with a special, self-organized learning regime, the individual function approximators automatically become specialized to various process dynamics contained in the training data. The specialization of the individual function approximators is then used to subdivide the time range under examination into sub-sections having different process dynamics.

The exemplary embodiment of this disclosure can be used in various stationary thermodynamic plants, in particular in power stations, waste incineration plants and cement works (i.e., plants for making cement). It is conceivable that the control loop according to the exemplary embodiment of this disclosure and the method of creating a process model for the control loop might also be used in other technical areas.

Other aspects and advantages of the present invention will become apparent from the following.

### BRIEF DESCRIPTION OF THE DRAWINGS

The present invention is described in more detail below on the basis of an exemplary embodiment depicted in the drawings, in which:

FIG. 1 is a diagrammatic view of a plant with a control loop according to the exemplary embodiment of the invention.

FIG. 2 illustrates the selection of a function approximator with the process model used.

FIG. 3 illustrates the subdivision of the entire time range in the second step of creating the process model.

FIG. 4 illustrates the result of calculating the prediction error in the fourth step of creating the process model.

FIG. 5 illustrates the new assignment of the time ranges in the fifth step of creating the process model.

### DETAILED DESCRIPTION OF EXEMPLARY EMBODIMENT

A plant 1, for example a coal-fired, oil-fired or gas-fired power station, a waste incineration plant or a cement works (i.e., a plant for making cement), comprises a furnace 3 (which should also be understood to mean a grate or other suitable device for use in facilitating the below-discussed combustion), at least one observation device 5 that can image the interior of the furnace 3 (or the grate), preferably further sensors 7, at least one adjustment device 9, and a computer 11 to which the observation device(s) 5, further sensors 7 and adjustment device(s) 9 are connected.

The furnace 3 is supplied with fuel or some other material to be converted, referred to as G for short, for example coal, oil, gas, waste, lime or similar, as well as with primary air (or primary oxygen) and secondary air (or secondary oxygen), referred to as L for short, and this supply is regulated by the adjustment devices 9 that are controlled by the computer 11. A combustion process takes place in the furnace 3. The resulting flame body F that is generated (as well as possibly emissions from the walls of the furnace 3) is continuously monitored by the observation devices 5. The observation devices 5 comprise in each case not only an optical access penetrating the wall of the furnace 3, for example a lance or a device as disclosed in EP 1 621 813 A and/or US 2006/024628 A1, but also a camera or the like operating in the optical range or in adjacent ranges of the electromagnetic wavelength spectrum. Preferably a camera with high temporal, local and spectral resolution should be used, of the type described, for example, in WO 02/070953 A1 and/or EP 1 364 164 B1.

The images of the flame body F (and of any possible emissions from the walls of the furnace 3) are evaluated in the computer 11, for example according to an eigenvalue method that is described in WO 2004/018940 A1 and/or U.S. Pat. No. 7,231,078 B2. The data obtained from the images of the flame body F, as well as the data from the other sensors 7, which measure for example the supply of material G and of air L, pollutant concentrations in the waste gases, or the concentration of free lime (FCAO), are treated as state variables s(t) that (as a function of time) describe the state of the system in the plant 1 in general, and of the combustion process in particular, and are to be considered as a vector.

The furnace 3 may be characterized as a controlled system, and the observation device(s) 5, the further sensors 7, the computer 11 and the adjustment devices 9 define a control loop. It is also possible to provide a conventional control loop comprising just a furnace 3, sensors 7, computer 11 (and/or regulators Rᵢ) and adjustment devices 9, but without the observation device(s) 5, with the control function of the control loop taking into account just a few state variables sₜ (i.e. it is low-dimensional), and then the control function of the control loop being optimized by incorporating the observation device(s) 5. The system in plant 1 can be set, for example, to certain set-point values or to maintain a stable process (i.e. smooth, quasi-stationary operation of the plant 1). In both cases, the state described by the actual values of the state variables is evaluated and, if necessary, appropriate adjusting actions, referred to as “actions”, for short, are selected to be carried out by the adjustment devices 9. In addition to the supplying of material G and air L, other activities performed by the adjustment devices 9, and possibly also a sample-taking, may be considered an action within the meaning of the exemplary embodiment of this disclosure. Disturbances can also be treated as undesired actions. Adjustable combinations of the two aforementioned control cases are conceivable, and they then represent compromises.

The evaluation of the state and the selection of the appropriate actions can, for example, be carried out according to a process such as that described in WO 02/077527 A1 and/or U.S. Pat. No. 7,035,717 B2. At least one neural network is implemented in the computer 11, and acting as a process model this neural network stores the reactions of the system states to actions, i.e. the (non-linear) links between the values of the state variables at a certain point in time and the actions then taken, on the one hand, and the resulting values of the state variables at a later point in time (i.e. later by a certain interval of time), on the other hand, namely links to as many points in time as possible in the past. In this sense, disturbances can also be included in the process model as (undesired) actions. A situation evaluation, which is conceived of as a simplified quality function and is independent of the process model, i.e. the stored links, evaluates the values of the state variables for a certain point in time and with respect to given optimization targets, i.e. with respect to determining how close the system state is to the optimum state at this point in time. By evaluating a predicted state—predicted using the process model as a function of a certain action—at a future point in time, it is possible to determine the suitability of the specific action for approaching the optimization target.

In order to improve the accuracy, the process models are continuously updated by the actual developments of the state variables as a reaction to actions. In addition, and as already known, competition typically is allowed to occur between several process models regarding the quality of the predictions. For this purpose, alternative process models, for example with other topologies, are created and trained in the background, and their predictions are compared with the currently used process model(s) in order, if necessary, to replace the currently used process model(s), as is described for example in EP 1 396 770 A1 and/or US 2005/137995 A1. The currently used process model then remains in use over a long period of time. The short-term process dynamics are not taken into consideration.

According to the exemplary embodiment of this disclosure, a process model that provides specialized function approximators for various process dynamics is created and used in order to be able to choose between specialized function approximators. Some aspects of the process model of the exemplary embodiment of this disclosure are described below in the context of, for example, six steps.

In a first step, a start is made by selecting n identical or differently structured function approximators FAi (i=1, . . . n), i.e. FA1 . . . FAn, which are intended to model the temporal behavior of the state variables sₜ. The time-dependent data that are available for training purposes from the observation device(s) 5 and from the other sensors 7 that may possibly also be present, i.e. the measured state variables sₜ, cover a certain overall time range ZB between a time t₀ and a time t₁. In a second step, this overall time range is subdivided into n individual, identically long, cohesive time ranges ZBi (i=1, . . . n), i.e. ZB1, . . . ZBn. Exactly one function approximator FAi is assigned to each time range ZBi.

In a third step, the function approximators FAi are trained for their respective time range ZBi, i.e. FA1 for ZB1, FA2 for ZB2, etc. Then, in a fourth step, all the function approximators FAi are tested over the overall time range ZB. For this purpose, in each case the prediction error eᵢ (i=1 . . . n), i.e. the deviation of the respective prediction of the function approximators FAi with respect to the defined target value (usually the actually measured state variable) is calculated. As a result, n different, time-dependent courses of the prediction errors e₁ are generated over the overall time range ZB.

In a fifth step, the time ranges are determined in which each function approximator FAi has achieved the smallest prediction error eᵢ, that is to say the best prediction result, and these time ranges are assigned to the respective function approximators FAi. It may happen that the sequence, preferably also the temporal length of the time ranges, changes compared with the respective preceding iteration (on the first occasion, therefore, compared with the start of the second step).

Therefore, in a sixth step, a check is performed to determine whether the arrangement of the time ranges is still undergoing changes. If this is the case, then the procedure returns to the third step. If it is not the case, then the procedure is discontinued in the converged state.

Once the procedure is converged, each function approximator FAi has specialized to a certain process dynamics that is clearly different from the others. For example, FA1 describes a basic behavior, FA2 describes a certain transient behavior, etc.

In operation according to the exemplary embodiment of the present invention, the process model created as described above must predict future states. To do this, a function approximator FAj is selected and currently used. At certain time intervals, which are preferably smaller than the time ranges ZBi used to create the process model, the use of the current function approximator FAj is automatically checked on the basis of the selection criteria: Using all n function approximators FAi, the prediction errors eᵢ are calculated for the state variables sₜ of the most recent past, i.e. the deviations between the predictions of the function approximators FAi and the current values of the state variables sₜ are calculated. The function approximator FAj with the currently smallest prediction error eⱼ is chosen using a first selector 21. This (possibly newly) selected function approximator FAj thus best represents the current process dynamics.

In each case, physically real regulators Rᵢ are assigned to the abstract function approximators FAi. In the exemplary embodiment of this disclosure, these regulators are organized in the computer 11, but they may also be separate devices. The first selector 21 therefore selects by way of a second regulator 22, for example a multiplexer, that particular regulator Rᵢ that corresponds to the chosen function approximator FAj with the smallest current prediction error eⱼ. The selected regulator Rⱼ regulates the control loop through acting by way of the adjustment devices 9 on the controlled system (the furnace 3).

It is thus possible to develop and automatically activate process models or parts of process models that are adapted to the respective process dynamics.

The entire disclosure of each of EP 1 621 813 A, US 2006/024628 A1, WO 02/070953 A1, EP 1 364 164 B1, WO 2004/018940 A1, U.S. Pat. No. 7,231,078 B2, WO 02/077527 A1, U.S. Pat. No. 7,035,717 B2, EP 1 396 770 A1 and US 2005/137995 A1 is incorporated herein by reference.

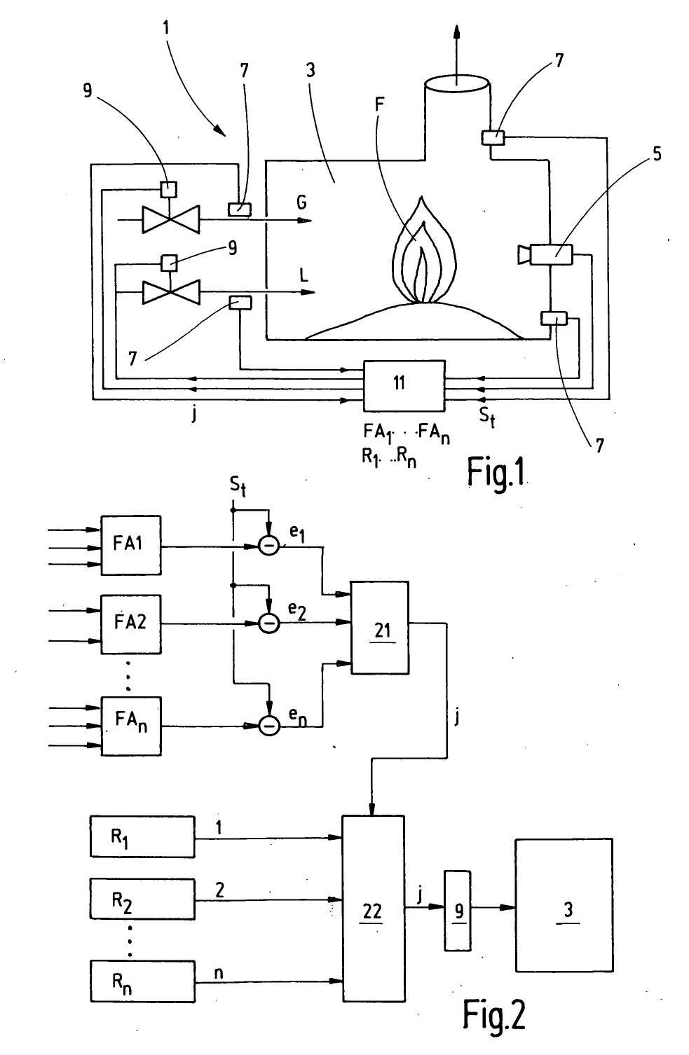

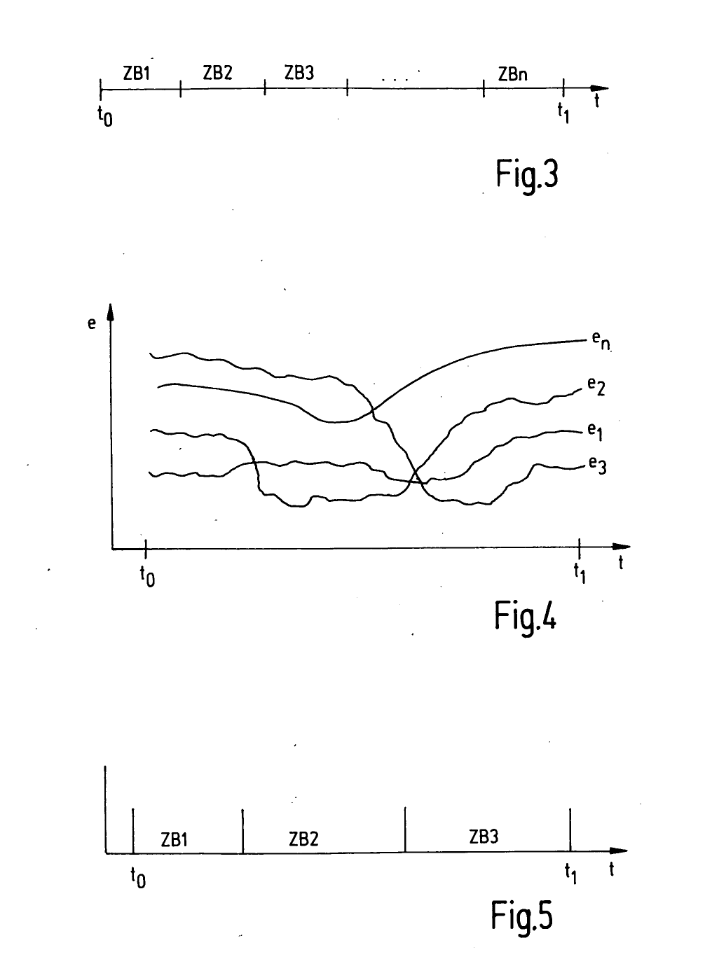

Generally described and in accordance with the exemplary embodiment of this disclosure, aspects of this disclosure may be embodied in software, firmware and/or hardware, such that aspects of FIG. 2 can be characterized as being software, firmware and/or hardware modules associated with a controller (e.g., the computer 11, which includes appropriate input and output devices, a processor, memory, etc.) for controlling the operation of the plant 1 by virtue of receiving data from and providing data (e.g., instructions from the execution of software modules stored in memory) to respective components 5, 7, 9. For this purpose and in accordance with the exemplary embodiment of this disclosure, the computer(s) 11 typically include or are otherwise associated with one or more computer-readable mediums (e.g., nonvolatile memory and/or volatile memory such as, but not limited to, flash memory, tapes and hard disks such as floppy disks and compact disks, or any other suitable storage devices) having computer-executable instructions (e.g., one or more software modules or the like), with the computer(s) handling (e.g., processing) the data in the manner indicated by the computer-executable instructions. Accordingly, aspects of FIGS. 1-5 can be characterized as respectively being schematically illustrative of the computer-readable mediums, computer-executable instructions and other features of methods and systems of the exemplary embodiment of this disclosure.

It will be understood by those skilled in the art that while the present invention has been discussed above with reference to an exemplary embodiment, various additions, modifications and changes can be made thereto without departing from the spirit and scope of the invention as set forth in the claims.

That which is claimed:

1. A control loop for regulating a combustion process in a plant having a controlled system for converting material by way of the process so that at least one flame body is formed, the control loop comprising:
sensors for determining state variables that describe a state of the system in the plant, wherein the sensors include at least one observation device for imaging at least the flame body;
a plurality of function approximators respectively specialized for different process dynamics;
a selector for selecting a function approximator of the plurality of function approximators;
a regulator assigned to the selected function approximator for evaluating the state variables and selecting suitable actions; and
at least one adjustment device for being controlled by the actions for supplying at least one supplied material to the process, wherein the at least one supplied material is selected from the group consisting of the material that is for being converted by the process and at least oxygen.

2. The control loop according to claim 1, wherein the selector uses selection criteria for selecting the selected function approximator, and the selection criteria is a minimal prediction error, so that the selector selects the selected function approximator on the basis of the minimal prediction error.

3. The control loop according to claim 2, wherein the minimal prediction error of the selected function approximator is calculated as a difference between:
a prediction of state variables by the selected function approximator, and
current values of the state variables.

4. The control loop according to claim 1, wherein use of the selected function approximator is checked at predetermined time intervals on the basis of a selection criteria used for selecting the selected function approximator.

5. The control loop according to claim 1, wherein the plant is adapted for performing at least one operation selected from the group consisting of generating power, incinerating waste, and making cement.

6. The control loop according to claim 1, comprising a computer, wherein:
the sensors and the adjustment device are connected to the computer; and
the plurality of function approximators and the selector are software modules executed by the computer.

7. A method for at least creating a process model that is for being used in a control loop for regulating a combustion process in a plant having a controlled system for converting material by way of the combustion process, the method comprising:
determining state variables that describe a state of the system in the plant;
specializing a plurality of function approximators respectively for different dynamics of the combustion process, including training the plurality of function approximators respectively to different time ranges; and
then selecting a function approximator of the plurality of function approximators.

8. The method according to claim 7, comprising the following steps that occur before the training of the plurality of function approximators respectively to the different time ranges:
selecting the plurality of function approximators;
subdividing an overall time range of time-dependent data available for training purposes into the different time ranges, and
then respectively assigning the plurality of function approximators to the different time ranges.

9. The method according to claim 7, comprising the following step that occurs after the training of the plurality of function approximators respectively to the different time ranges:
testing the plurality of function approximators over the overall time range.

10. The method according to claim 9, wherein the testing of the plurality of function approximators over the overall time range comprises calculating prediction errors respectively for the plurality of function approximators.

11. The method according to claim 10, wherein the calculating of the prediction errors respectively for the plurality of function approximators comprises calculating for each of the plurality of function approximators a difference between:
(a) a prediction of state variables by the function approximator, and
(b) current values of the state variables.

12. The method according to claim 10, comprising determining time ranges respectively in which the plurality of function approximators have achieved the smallest prediction errors, and assigning the determined time ranges respectively to the plurality of function approximators.

13. The method according to claim 12, comprising performing a check to determine whether the determined time ranges are undergoing change.

14. The method according to claim 13, comprising retraining the function approximators in response to determining that the determined time ranges are undergoing change.

15. The method according to claim 13, comprising determining that a converged state has been reached in response to determining that the determined time ranges are not undergoing substantial change.

16. The method of claim 7, further comprising using a regulator, which is assigned to the selected function approximator, to evaluate the state variables and select suitable actions, wherein the actions are for controlling at least one adjustment device for supplying at least one supplied material to the combustion process, and the at least one supplied material is selected from the group consisting of the material that is for being converted by the combustion process and at least oxygen.

17. The method according to claim 7, wherein:
the determining of the state variables comprises using sensors for determining the state variables; and
the using of the sensors comprises using at least one observation device for imaging at least one flame body of the combustion.

18. The method according to claim 7, wherein:
the selecting of the function approximator comprises using selection criteria;
the selection criteria comprises a minimal prediction error;
the method comprises determining the minimal prediction error of the selected function approximator; and
the determining of the minimal prediction error of the selected function approximator comprises calculating a difference between
(a) a prediction of state variables by the selected function approximator, and
(b) current values of the state variables.

19. The method according to claim 18, comprising checking usage of the selected function approximator at predetermined time intervals on the basis of the selection criteria.

20. A computer-readable medium having computer-executable instructions for performing the method of claim 7.
